(19) United States
(12) Patent Application Publication
(10) Pub. No.: US 2009/0264141 A1
(43) Pub. Date: Oct. 22, 2009

(54) Robust Location Detection Based on Identifying Codes

(76) Inventors: Marilynn Green, Coppell, TX (US); Shu-Shaw Wang, Arlington, TX (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/992,038

(22) PCT Filed: Sep. 13, 2005
(86) PCT No.: PCT/IB2005/002708

§ 371 Date: Mar. 13, 2008

(51) Int. Cl. H04B 7/00

(52) U.S. Cl. 455/500

(57) ABSTRACT

Positioning beacons (109-a . . . 109-d; 602-1 . . . 602-K) are shown in a target area (100) of a location detection system (600) with location areas (103-a . . . 103-g) in the target area associated with potential beacon positions (102-a . . . 102-g) and represented by vertices (106-a . . . 106-g) of a graph (105). Reliable connectivity between location areas is represented by edges between vertices that represent the location areas. The beacons are assigned to location areas of a subset of vertices of the graph, which subset represents a robust 1-identifying code. The graph may be constrained to a regular topology to exploit availability of optimum or close-to-optimum t-edge-robust and t-vertex-robust 1-identifying codes for such regular topologies. A greedy search algorithm (400-425) may be used to find a small subset of vertices representing t-vertex-robust 1-identifying codes.

### CROSS-REFERENCE TO RELATED APPLICATION

The application is the U.S. National Stage of International Application Number PCT/IB2005/002708 filed Sep. 13, 2005.

### FIELD OF THE INVENTION

This invention relates to methods, software applications and software application products for positioning beacons in target areas of location detection systems, and to such location detection systems themselves.

### BACKGROUND OF THE INVENTION

Document “Grid coverage for surveillance and target location in distributed sensor networks” by Chakrabarty, K., Iyengar, S. S., Qi, H. and Cho, E., IEEE Transactions on Computers, Vol. 51, Issue 12, December 2002, pp. 1448-1453 introduces “identifying codes” as a method to uniquely identify faulty processors in multiprocessor systems.

Microprocessors are generally arranged in regular topologies (such as hyper-cubes, meshes, etc.). In order to detect faults, some of the processors must serve as both processing units as well as fault detection units with alarm capability. In its role as a detection unit, a processor checks its r-radius neighborhood (including itself) in order to determine if there have been any processor failures and the instance or lack of an r-radius failure is then reported to some central system management unit.

Coding theory suggests that there is an optimal way to select the detection units so that: (1) the number of processors that must also serve as detection units is minimized and (2) a faulty processor can be uniquely detected by observing the subset of detection units that report a failure. Each detection unit has only to report YES if it detects at least one failure and NO if there are no failures in its r-radius neighborhood. The identifying code that is formed by the concatenation of YES/NO (1/0) votes from all of the detection units is reviewed at a central unit in order to uniquely determine which one of the processors is faulty. The subset of detection units that can detect a particular processor is known as its identifying set and, by definition, every detection unit is also a part of its own identifying set.

Document “On Robust Identifying Codes” by Honkala, I., Karpovsky, M. G. and Levitin, L. B., submitted to IEEE Transactions on Information Theory, February 2004, introduces the concept of “robust identifying codes”, which may either be “t-edge-robust r-identifying” or “t-vertex-robust r-identifying”. These types of identifying codes are used to provide error detection in the design of fault detection systems.

A t-edge-robust r-identifying code can identify the faulty processor if the code that is reported to the central system unit is in error by no more than t bits. Bit errors may be caused by two different events: false detections and missed detections. If a processor is in fault and a detection unit that is not a member of its identifying set detects that fault, then a false detection has occurred. A missed detection occurs when a detection unit that is a member of a processor's identifying set does not detect its faultiness.

Similarly, also a t-vertex-robust r-identifying codeword can identify the faulty processor if its identifying set is in error by no more than t bits. However, in this case, the bit errors may be caused by three different events: (1) false detection by a non-member of its identifying set, (2) missed detection by a member of the identifying set, and (3) missed self-fault detection by a unit that serves both as a processor and as a detection unit.

The Honkala et al. reference provides lower bounds for the densities (i.e. the ratio between required detection units and processors) of optimal t-edge-robust and t-vertex-robust 1-identifying codes as well as examples of optimal and close-to-optimal t-edge-robust and t-vertex-robust 1-identifying codes that have been discovered for the special case of regular graph topologies (for instance triangular, square, hexagonal topologies or the King's lattice topology).

Location detection of the nodes in a sensored field has recently become a burgeoning area of research. While the Global Positioning System (GPS) and its derivative technologies (such as the Assisted-GPS method) and the methods that are supported by the cellular infrastructure of a wireless communication system (such as Advanced Forward Link Trilateration) can, in many cases, satisfy many of the requirements for outdoor location detection, their effectiveness diminishes when there is a strong attenuation of the radio signal (such as in an indoor environment) or when the line of sight between the network and the terminal of a wireless communication system is blocked.

Document “Grid Coverage for Surveillance and Target Location in Distributed Sensor Networks” by Chakrabarty, K., Iyengar, S. S., Qi, H. and Cho, E., in IEEE Transactions on Computers, Vol. 51, No. 12, December 2002, pp. 1448-1453 proposes the use of identifying codes for location detection in sensor networks. This location detection approach uses the theory of optimal identifying codes as a basis for determining where to place a (minimum) number of sensors (beacons) for target detection. The approach is based on the assumption of a regular mesh topology underlying said sensor network, but does not incorporate any robustness against failure of communication links and/or failure of beacons.

Document “Robust Location Detection in Emergency Sensor Networks” by Ray, S., Ungrangsi, R., De Pellegrini, F., Trachtenberg, A. and Starobinski, D., in Proceedings 22^{nd} Annual Joint Conference of the IEEE Computer and Communications Societies (INFOCOM), Mar. 30-Apr. 3, 2003, Vol. 2, pp. 1044-1053 proposes a new framework for providing robust location detection in emergency response systems, based on the theory of identifying codes.

A location detection system is modeled as a graph by dividing a continuous coverage area into a finite set of regions. Each region is represented by a single point within its boundary. These points correspond to nodes in a graph and nodes are connected by links in the graph if the corresponding points in the physical system are able to communicate directly. The identifying code problem then is to determine the nodes on which to place codewords such that each node of the graph is covered by a unique set of sensors; the location detection analog of this would be to designate special sensor nodes in a way that every node in the graph is within communication range of a unique set of sensors. To find an optimal identifying code for an arbitrary graph, a greedy algorithm is proposed, which produces irreducible identifying codes (an identifying code is irreducible if no codeword can be removed while still keeping every position uniquely identifiable).

Furthermore, the concept of “r-robust” identifying codes is introduced (wherein the definition of these “r-robust” 1-identifying codes slightly differs from the definition of the t-vertex-robust 1-identifying codes as given in Honkala et al.). An according greedy search algorithm is proposed that produces irreducible “r-robust” codes. According to this algorithm, nodes of a graph are first ordered (in ascending, descending or random order). The algorithm then starts from a set containing all nodes of the graph, visits each node in order, one by one, and attempts to remove it. If the resulting set still represents an “r-robust” code, the removed node is not placed back into the set. Otherwise, that node is placed back into the set. Then, the next node, in order, is removed. This yields, for a specific order, one “r-robust” code, which strongly depends on said specific order and thus may be far from optimum (i.e. may have a larger cardinality than actually required).

### SUMMARY OF THE INVENTION

Setting out from this prior art, it is, inter alia, an object of the present invention to propose methods, software applications and software application products for positioning beacons in a target area of a location detection system that lead to improved location detection systems.

It is a further object of the present invention to propose improved location detection systems.

### FIRST ASPECT OF THE INVENTION

According to a first aspect of the present invention, a method for positioning beacons in a target area of a location detection system is proposed. Said method comprises dividing said target area into a plurality of location areas associated with potential beacon positions, wherein said location areas are represented by vertices of a graph, wherein reliable connectivity between location areas is represented by edges between vertices that represent said location areas, and wherein said graph has a regular topology; and assigning said beacons to location areas that are represented by a sub-set of vertices of said graph, wherein said sub-set of vertices represents a t-edge-robust 1-identifying code or a t-vertex-robust 1-identifying code, and wherein t is a pre-defined integer number.

Said location detection system, which may be an indoor or outdoor two-dimensional or three-dimensional location detection system, is capable of determining a location of a target within said target area with a certain granularity, for instance at an location-area level.

Location detection may be performed by the target by evaluating from which set of beacons identification (ID) signals can be received, or by a central unit, which evaluates by which set of beacons ID signals from a target can be received. Therein, said ID signals may be transmitted by all means of wire-bound or wireless physical media, for instance via radio or optical channels or via cables. In case of a wireless physical medium, wireless protocols such as the Bluetooth, Radio Frequency Identification (RFID), Wireless Local Area Network (WLAN), Ultra-Wideband or similar wireless protocols may be applied. Said location detection system does not necessarily have to be a stand-alone system, it may equally well be integrated into a system of different purpose, as for instance a wireless communication system, as for instance a cellular radio system or a Wireless Local Area Network (WLAN) system. Then at least some of said beacons may be access units, for instance base stations or access points, of said wireless communication system, and at least some of said targets may be mobile stations or terminals of said wireless communication system.

A location area, which is associated with a potential beacon position, may for instance be defined by the plurality of positions in the target area from which a target would be able to establish, with a high probability, a reliable connection with a beacon positioned at the potential beacon position of said location area and a set of beacons that are positioned at further potential beacon positions in said target area, wherein said set of beacons may comprise zero, one or more beacons. All of said points in said location area are thus in the coverage area of the beacon positioned in the potential beacon position of said location area and in the coverage area of beacons of said set of beacons.

Location areas may advantageously be disjoint (non-overlapping), while coverage areas of beacons may overlap. A beacon may be assigned to such a potential beacon position of a location area or not in dependence on the outcome of said method for positioning beacons. Reliable connectivity between a first and a second location area may be understood as a situation where a target in a first location area can establish, with a high probability, a reliable connection with a beacon positioned at the potential beacon position of said second location area, wherein said reliability may for instance be related to an average or actual received signal power or Signal-to-Noise Ratio (SNR) that may not be undershot. In a wireless location detection system, this received signal power or SNR may for instance be affected by free-space loss, short-term and/or long-term fading.

Said target area is divided into location areas in a way that said location areas (which are associated with potential beacon positions, respectively) can be represented by a graph with regular topology, for instance a triangular, square, hexagonal topology or a King's lattice topology, to name but a few.

Said beacons are assigned to location areas corresponding to a sub-set of vertices of said graph, wherein said sub-set of vertices represents a t-edge-robust or t-vertex-robust 1-identifying code for said graph. Therein, a 1-identifying code is defined to represent a subset of vertices that only comprises vertices with unique identifying sets, wherein in each identifying set of a vertex, only directly neighboring vertices can be contained (i.e. vertices within radius r=1 in a vertex-scale). A t-edge-robust 1-identifying code is a 1-identifying code that can still correctly identify a location area if not more than t beacons cause a false detection (i.e. a detection of a target in a location area that is not within the identifying set of the detecting beacon) or a missed detection (i.e. a beacon does not detect a target in a location area of its identifying set) of a target. A t-vertex-robust 1-identifying code is a 1-identifying code that can still correctly identify a location area if not more than t beacons of said graph cause a false detection of a target, a missed detection of a target or a missed self-detection (i.e. a beacon does not detect a target in its own coverage area). Said predefined integer number t is related to the robustness of the system and may for instance be chosen equal to 1 or 2.

According to the first aspect of the present invention, robustness of the location detection unit against a pre-determined number t of false detections, missed detections and missed self-detections is provided. Furthermore, said graph representing said location areas (vertices) and their associated connectivity (edges) is constrained to a regular topology, which allows to use optimal or close-to-optimal t-edge-robust or t-vertex-robust identifying codes, with optimality referring to the density of said 1-identifying codes, i.e. the ratio between actually deployed beacons and total number of potential beacon positions (respectively associated with location areas) in said target area. For instance, for a square topology, lower bounds (i.e. minimal achievable values) for the density of 1-vertex-robust and 2-vertex-robust 1-identifying codes can be derived, so that a 1-identifying code that reaches these lower bounds can be considered as optimal 1-identifying code, and a 1-identifying code that comes close to said bound may be considered as a close-to-optimal code. In contrast, for arbitrary graph topologies, no lower bounds can be derived, so that it is difficult to decide if a 1-identifying code, which may for instance be generated by some kind of brute force search algorithm, has converged to a minimum density or is still rather inefficient.

Thus according to the first aspect of the present invention, a robust and efficient location detection system is obtained under the constraint of a regular topology of the graph that represents the potential beacons positions and their connectivity.

Said method of the first aspect of the present invention may for instance be embodied in a device that comprises means for dividing said target area into a plurality of location areas, and means for assigning said beacons to location areas.

According to an embodiment of the method of the first aspect of the present invention, a pre-defined set of possible combinations of t-edge-robust or t-vertex-robust 1-identifying codes and regular topologies exists, said method further comprising selecting one of said possible combinations of 1-identifying codes and regular topologies of said pre-defined set, wherein said dividing of said target area into a plurality of location areas is performed based on said topology of said selected combination of 1-identifying codes and regular topologies, and wherein said assigning of said beacons to said location areas is performed based on said t-edge-robust or t-vertex-robust 1-identifying code of said selected combination of 1-identifying codes and regular topologies.

Said pre-defined set of possible combinations of 1-identifying codes and regular topologies may for instance comprise a plurality of optimal and/or close-to-optimal 1-identifying codes with their associated regular topologies. From said set, a suited combination is selected, for instance by a user or automatically, and the steps of dividing said target area into said plurality of location areas as indicated by said selected regular topology and assigning said beacons to locations areas as indicated by said selected 1-identifying code is performed. Therein, said selecting of said combination and said dividing of said target area may equally well be jointly performed, since it may be required to adapt the location areas so that a regular graph topology can be achieved.

Said selecting may for instance be performed under consideration of characteristics of said target area and/or said location detection system. Said parameter t, which controls the robustness of the location detection systems against errors, may be considered as a characteristic of said location detection system, as well as the number of required beacons. The layout of the target area and the ease of installation of beacons may for instance be considered as characteristics of said target area.

According to a further embodiment of the method of the first aspect of the present invention, said regular topology is a triangular topology, and said 1-identifying code is an optimal 1-edge-robust 1-identifying code with density 3/7, a 1-vertex-robust 1-identifying code with density 3/5 or an optimal 2-vertex-robust 1-identifying code with density 11/12. These 1-identifying codes may for instance be comprised in said pre-defined set of possible combinations of t-edge-robust or t-vertex-robust 1-identifying codes and regular topologies.

According to a further embodiment of the method of the first aspect of the present invention, said regular topology is a King's lattice topology, and said 1-identifying code is a 1-edge-robust 1-identifying code with density 3/8, an optimal 1-vertex-robust 1-identifying code with density 1/2 or an optimal 2-vertex-robust 1-identifying code with density 5/6. These 1-identifying codes may for instance be comprised in said pre-defined set of possible combinations of t-edge-robust or t-vertex-robust 1-identifying codes and regular topologies.

According to a further embodiment of the method of the first aspect of the present invention, said regular topology is a hexagonal topology, and said 1-identifying code is an optimal 1-edge-robust 1-identifying code with density 2/3, or a 1-vertex-robust 1-identifying code with density 41/50. These 1-identifying codes may for instance be comprised in said pre-defined set of possible combinations of t-edge-robust or t-vertex-robust 1-identifying codes and regular topologies.

According to a further embodiment of the method of the first aspect of the present invention, said regular topology is a square topology, and said 1-identifying code is an optimal 1-vertex-robust 1-identifying code with density 5/8 or an optimal 2-vertex-robust 1-identifying code with density 11/12. These 1-identifying codes may for instance be comprised in said pre-defined set of possible combinations of t-edge-robust or t-vertex-robust 1-identifying codes and regular topologies.

According to a further embodiment of the method of the first aspect of the present invention, said target area of said location detection system at least partially overlaps with a coverage area of a wireless communication system, and wherein at least some of said beacons serve as access units of said wireless communication system. Location detection functionality of said location detection system then may for instance be partly or entirely implemented by said wireless communication system.

Said positioning of said beacons of said location detection system serving as access units of said wireless communication system may then be performed under consideration of said assignment of said beacons to said location areas and under additional consideration of characteristics of said wireless communication system. Characteristics of said wireless communication system may for instance be related to frequency planning, performance optimization and capacity optimization, which all may affect the positioning of the access units of said wireless communication system. For instance, the positioning of the access units of said wireless communication system and of the beacons of said location detection system may be at least partially jointly optimized.

According to the first aspect of the present invention, furthermore a location detection system is proposed. Said system comprises a plurality of beacons positioned in a target area, wherein said target area is divided into a plurality of location areas associated with potential beacon positions, wherein said location areas are represented by vertices of a graph, wherein reliable connectivity between location areas is represented by edges between vertices that represent said location areas, wherein said graph has a regular topology, wherein said beacons are positioned in location areas that are represented by a sub-set of vertices of said graph, wherein said sub-set of vertices represents a t-robust 1-identifying code for said graph, wherein said t-robust 1-identifying code is either a t-edge-robust 1-identifying code or a t-vertex-robust 1-identifying code, and wherein t is a pre-defined integer number.

Therein, the characteristics and advantages already outlined in the discussion of the method of the first aspect of the present invention equally apply to said location detection system of the first aspect of the present invention.

According to an embodiment of the location detection system of the first aspect of the present invention, the system further comprises a plurality of targets, and a target location determination unit, wherein targets are at least temporarily associated with beacons, wherein beacons forward identifiers of their associated targets to said target location determination unit, and wherein said target location determination unit is capable of determining a location area of a target based on an evaluation of those beacons that are known to be associated with said target. Said targets may for instance be static or mobile Bluetooth-capable devices, and said beacons may for instance be static Bluetooth-capable devices, which may be Bluetooth masters or Bluetooth slaves. An association between targets and beacons then may for instance be accomplished by means of Bluetooth inquiry calls launched by the beacons, and by means of Frequency Hopping Synchronization (FHS) packets transmitted by the targets in response to the Bluetooth inquiry calls, wherein said FHS packets may comprise addresses of said targets.

According to an embodiment of the location detection system of the first aspect of the present invention, at least one beacon of said location detection system at least occasionally checks operability of at least one other beacon of said location detection system. In a Bluetooth-based system, beacons may for instance check operability of other beacons of their identifying set by triggering inquiry calls and checking if corresponding FHS packets are received from said other beacons. Checking operability of beacons allows avoiding beacon failure and this increases robustness of the location detection system.

According to the first aspect of the present invention, furthermore a software application for positioning beacons in a target area of a location detection system is proposed. Said software application comprises program code for dividing said target area into a plurality of location areas associated with potential beacon positions, wherein said location areas are represented by vertices of a graph, wherein reliable connectivity between location areas is represented by edges between vertices that represent said location areas, and wherein said graph has a regular topology; and program code for assigning said beacons to location areas that are represented by a sub-set of vertices of said graph, wherein said sub-set of vertices represents a t-edge-robust or a t-vertex-robust 1-identifying code, and wherein t is a pre-defined integer number.

According to the first aspect of the present invention, furthermore a software application product is proposed, comprising a storage medium having said software application of the first aspect of the present invention embodied therein.

Therein, the characteristics and advantages already outlined in the discussion of the method of the first aspect of the present invention equally apply to said software application and said software application product of the first aspect of the present invention.

### SECOND ASPECT OF THE INVENTION

According to a second aspect of the present invention, a method for positioning beacons in a target area of a location detection system is proposed, wherein location areas are associated with potential beacon positions in said target area and are represented by vertices of a graph, wherein reliable connectivity between location areas is represented by edges between vertices that represent said location areas, and wherein all vertices of said graph form a set V. Said method comprises:
determining a plurality of sets C, each of said sets C being determined by repeating, until a set A is determined to be empty, the following steps:
   determining said set A as a set of all vertices that, if removed from said set C, would still cause the remaining vertices in said set C to represent a t-vertex-robust 1-identifying code for said graph, wherein t is a pre-defined integer number, and wherein for the determining of each of said plurality of sets C, said set V is used as an initialization for said set C;
   removing, if said set A is non-empty, one randomly selected vertex of said set A from said set C to obtain said set C for said next determining of said set A; and
   returning, if said set A is empty, said set C as the result of said determining of said set C; and
assigning said beacons to those location areas that are represented by vertices of that set C of said plurality of determined sets C that has the smallest cardinality.

Said location detection system, which may be an indoor or outdoor two-dimensional or three-dimensional location detection system, is capable of determining a location of a target within said target area with a certain granularity, for instance at an location-area level. Location detection may be performed by a target by evaluating from which set of beacons identification (ID) signals can be received, or by a central unit, which evaluates by which set of beacons ID signals from a target can be received. Therein, said ID signals may be transmitted by all means of wire-bound or wireless physical media, for instance via radio or optical channels or via cables. In case of a wireless physical medium, wireless protocols such as the Bluetooth, Radio Frequency Identification (RFID), Wireless Local Area Network (WLAN), Ultra-Wideband or similar wireless protocols may be applied.

Said location detection system does not necessarily have to be a stand-alone system, it may equally well be integrated into a system of different purpose, as for instance a wireless communication system. Then at least some of said beacons may be access units, for instance base stations or access points, of said wireless communication system, and at least some of said targets may be mobile stations or terminals of said wireless communication system.

Location areas are understood to be associated with potential beacon positions, wherein a beacon may be assigned to such a potential beacon position or not in dependence on the outcome of said method for positioning beacons.

A location area, which is associated with a potential beacon position, may for instance be defined by the plurality of positions in the target area from which a target would be able to establish, with a high probability, a reliable connection with a beacon positioned at the potential beacon position of said location area and a set of beacons that are positioned at further potential beacon positions in said target area, wherein said set of beacons may comprise zero, one or more beacons. All said points in said location area are thus in the coverage area of the beacon positioned in the potential beacon position of said location area and in the coverage area of beacons of said set of beacons. Location areas may advantageously be disjoint (non-overlapping), while coverage areas of beacons may overlap.

Reliable connectivity between a first and a second location area may be understood as a situation where a target in a first location area can establish, with a high probability, a reliable connection with a beacon positioned at the potential beacon position of said second location area, wherein said reliability may for instance be related to an average or actual received signal power or Signal-to-Noise Ratio (SNR) that may not be undershot. In a wireless location detection system, this received signal power or SNR may for instance be affected by free-space loss, short-term and/or long-term fading.

Basically, a plurality of sets C is determined, for instance 10-15 sets C. From said plurality of sets C, the set C with the smallest cardinality, i.e. the smallest number of vertices, is selected. Beacons are assigned to those location areas that are represented by the vertices of said selected set of vertices C.

Each set C is determined by setting out from the set V and removing vertices from said set in a randomized order to obtain a set of vertices C that has a small cardinality and still represents a t-vertex-robust 1-identifying code.

Therein, a 1-identifying code is defined to represent a subset of vertices that only comprises vertices with unique identifying sets, wherein in each identifying set of a vertex, only directly neighboring vertices can be contained (i.e. vertices within radius r=1 in a vertex-scale). A t-vertex-robust 1-identifying code is defined as a code that can still correctly identify a location area if not more than t beacons of said graph cause a false detection of a target, a missed detection of a target or a missed self-detection (i.e. a beacon does not detect a target in its own coverage area).

According to the second aspect of the present invention, robustness and efficiency of the location detection is ensured, since the set of vertices C according to which the assigning of beacons to location areas is performed is selected to represent a t-vertex-robust 1-identifying code and has a small cardinality. The method allows to position beacons in target areas without constraining said graph that represents the location areas of the target area and their connectivity to a regular topology (as for instance a triangular or square topology). In contrast to prior art, the set of vertices C produced by the method does not depend on an arrangement of the vertices of said graph. By increasing the number of sets of vertices C that are determined, convergence to sets of vertices C with a small cardinality (and thus a high efficiency of the location detection system) can be ensured.

Said method of the second aspect of the present invention may for instance be embodied in a device that comprises means for determining a plurality of sets C, and means for assigning said beacons to location areas represented by vertices of the set C that has the smallest cardinality.

According to an embodiment of the method of the second aspect of the present invention, said target area of said location detection system at least partially overlaps with a coverage area of a wireless communication system, and at least some of said beacons serve as access units of said wireless communication system.

According to a further embodiment of the method of the second aspect of the present invention, said target area of said location detection system at least partially overlaps with a coverage area of a wireless communication system, and wherein at least some of said beacons serve as access units of said wireless communication system. Location detection functionality of said location detection system then may for instance be partly or entirely implemented by said wireless communication system.

Said positioning of said beacons of said location detection system serving as access units of said wireless communication system may then be performed under consideration of said assignment of said beacons to said location areas and under additional consideration of characteristics of said wireless communication system. Characteristics of said wireless communication system may for instance be related to frequency planning, performance optimization and capacity optimization, which all may affect the positioning of the access units of said wireless communication system. For instance, the positioning of the access units of said wireless communication system and of the beacons of said location detection system may be at least partially jointly optimized.

According to the second aspect of the present invention, furthermore a location detection system is proposed. Said location detection system comprises a plurality of beacons positioned in a target area, wherein said beacons are positioned in said target area according to an assignment of beacons to location areas of said target area, wherein said location areas are associated with potential beacon positions in said target area and are represented by vertices of a graph, wherein reliable connectivity between location areas is represented by edges between vertices that represent said location areas, wherein all vertices of said graph form a set V, and wherein a determination of said assignment of said beacons to said location areas comprises:
determining a plurality of sets C, each of said sets C being determined by repeating, until a set A is determined to be empty, the following steps:
   determining said set A as a set of all vertices that, if removed from said set C, would still cause the remaining vertices in said set C to represent a t-robust 1-identifying code for said graph, wherein t is a pre-defined integer number, and wherein for the determining of each of said plurality of sets C, said set V is used as an initialization for said set C;
   removing, if said set A is non-empty, one randomly selected vertex of said set A from said set C to obtain said set C for said next determining of said set A; and
   returning, if said set A is empty, said set C as the result of said determining of said set C; and
assigning said beacons to those location areas that are represented/by vertices of that set C of said plurality of determined sets C that has the smallest cardinality.

Therein, the characteristics and advantages already outlined in the discussion of the method of the first aspect of the present invention equally apply to the location detection system of the second aspect of the present invention.

According to an embodiment of the location detection system of the second aspect of the present invention, the system further comprises a plurality of targets, and a target location determination unit, wherein targets are at least temporarily associated with beacons, wherein beacons forward identifiers of their associated targets to said target location determination unit, and wherein said target location determination unit is capable of determining a location area of a target based on an evaluation of those beacons that are known to be associated with said target. Said targets may for instance be static or mobile Bluetooth-capable devices, and said beacons may for instance be static Bluetooth-capable devices, which may be Bluetooth master or Bluetooth slaves. An association between targets and beacons then may for instance be accomplished by means of Bluetooth inquiry calls launched by the beacons, and by means of Frequency Hopping Synchronization (FHS) packets transmitted by the targets in response to the Bluetooth inquiry calls, wherein said FHS packets may comprise addresses of said targets.

According to an embodiment of the location detection system of the second aspect of the present invention, at least one beacon of said location detection system at least occasionally checks operability of at least one other beacon of said location detection system. In a Bluetooth-based system, beacons may for instance check operability of other beacons of their identifying set by triggering inquiry calls and checking if corresponding FHS packets are received from said other beacons. Checking operability of beacons allows to avoid beacon failure and this increases robustness of the location detection system.

According to the second aspect of the present invention, furthermore a software application for positioning beacons in a target area of a location detection system is proposed, wherein location areas are associated with potential beacon positions in said target area and are represented by vertices of a graph, wherein reliable connectivity between location areas is represented by edges between vertices that represent said location areas, and wherein all vertices of said graph form a set V. Said software application comprises program code for determining a plurality of sets C, each of said sets C being determined by repeating, until a set A is determined to be empty, the following steps: determining said set A as a set of all vertices that, if removed from said set C, would still cause the remaining vertices in said set C to represent a t-vertex-robust 1-identifying code for said graph, wherein t is a pre-defined integer number, and wherein for the determining of each of said plurality of sets C, said set V is used as an initialization for said set C; removing, if said set A is non-empty, one randomly selected vertex of said set A from said set C to obtain said set C for said next determining of said set A; and returning, if said set A is empty, said set C as the result of said determining of said set C; and program code for assigning said beacons to those location areas that are represented by vertices of that set C of said plurality of determined sets C that has the smallest cardinality.

According to the second aspect of the present invention, furthermore a software application product is proposed, comprising a storage medium having said software application of the second aspect of the present invention embodied therein.

Therein, the characteristics and advantages already outlined in the discussion of the method of the second aspect of the present invention equally apply to said software application and said software application product of the second aspect of the present invention.

These and other aspects of the invention will be apparent from and elucidated with reference to the embodiments described hereinafter.

### BRIEF DESCRIPTION OF THE FIGURES

In the figures show:

FIG. 1a: a schematic representation of a target area of a location detection system;

FIG. 1b: a schematic representation of a target area of a location detection system with potential beacon positions and associated location areas;

FIG. 1c: a schematic representation of a target area of a location detection system with illustrated connectivity between potential beacon positions;

FIG. 1d: a graph representing the potential beacon positions of FIG. 1c and their connectivity;

FIG. 1e: a graph representing the potential beacon positions in the target area of FIG. 1c and beacons assigned to potential beacon positions;

FIG. 1f: a schematic representation of the target area of a location detection system according to FIG. 1b with potential beacon positions and assigned beacons according to the graph of FIG. 1e;

FIG. 2a: an optimal 1-edge-robust 1-identifying code with density 3/7 for a graph with triangular topology;

FIG. 2b: a 1-edge-robust 1-identifying code with density 3/8 for a graph with King's lattice topology;

FIG. 2c: an optimal 1-edge-robust 1-identifying code with density 2/3 for a graph with hexagonal topology;

FIG. 2d: an optimal 1-vertex-robust 1-identifying code with density 5/8 for a graph with square topology;

FIG. 2e: an optimal 1-vertex-robust 1-identifying code with density 1/2 for a graph with King's lattice topology;

FIG. 2f: a 1-vertex-robust 1-identifying code with density 3/5 for a graph with triangular topology;

FIG. 2g: a 1-vertex-robust 1-identifying code with density 41/50 for a graph with hexagonal topology;

FIG. 2h: an optimal 2-vertex-robust 1-identifying code with density 11/12 for a graph with square topology;

FIG. 2i: an optimal 2-vertex-robust 1-identifying code with density 11/12 for a graph with triangular topology;

FIG. 2j: an optimal 2-vertex-robust 1-identifying code with density 5/6 for a graph with King's lattice topology;

FIG. 3: a flowchart of an exemplary embodiment of a method for positioning beacons in a target area of a location detection system according to the first aspect of the present invention;

FIG. 4a: a first part of a flowchart of an exemplary embodiment of a search algorithm for determining a t-vertex-robust 1-identifying code for an arbitrary graph according to the second aspect of the present invention;

FIG. 4b: a second part of a flowchart of an exemplary embodiment of a search algorithm for determining a t-vertex-robust 1-identifying code for an arbitrary graph according to the second aspect of the present invention;

FIG. 5: a flowchart of an exemplary embodiment of a method for detecting a location of a target in the location detection system of the first and second aspect of the first and second aspect of the present invention; and

FIG. 6: a schematic block diagram of a location detection system according to first and second aspect of the present invention.

### DETAILED DESCRIPTION OF THE INVENTION

In this invention, the theory of “robust identifying codes” is applied in order to robustly locate a target in a target area of a location detection system. To this end, a plurality of beacons is distributed across the target area of the location detection system. The key concept of robust location detection is to construct a solution space that allows one to identify the location area of a target by simply noting the unique subset of beacons that can detect it. Each beacon reports a “1” if it detects a specific target and a “0” if it does not. The concatenation of these 1-bit reports at a target location detection unit forms a codeword that may be used in order to uniquely identify the location area of the target (If several targets are to be located, the 1-bit reports of the beacons may be associated with according IDs of the targets to enable the target location detection unit to differentiate the targets). This solution is also designed to be robust so that it can still provide a unique solution in the presence of beacon hardware failure or a missing beacon, radio link fluctuation that results in a missed target and radio link fluctuation that results in a falsely detected target.

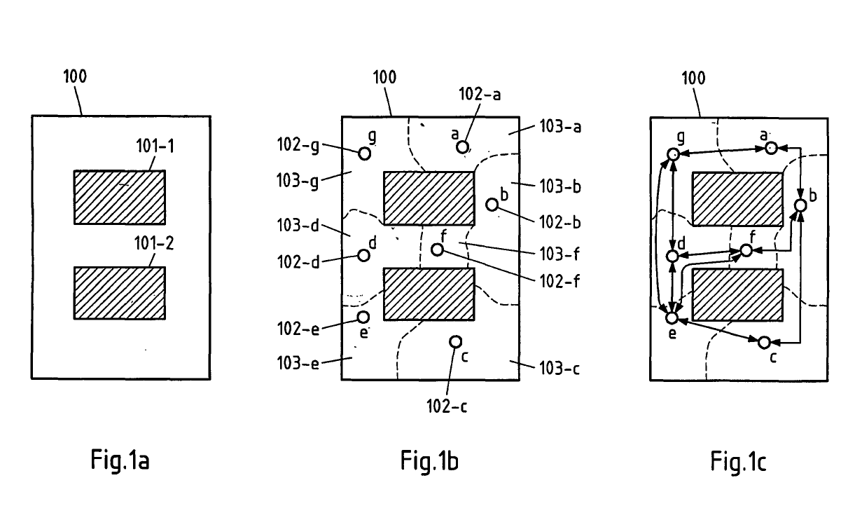

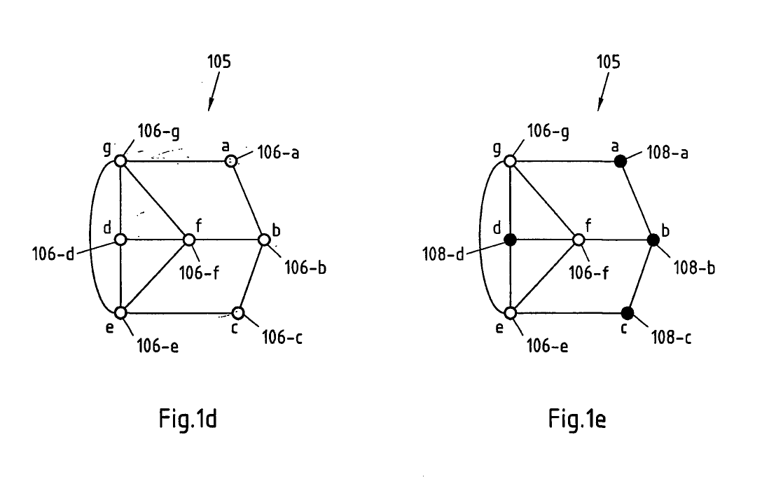

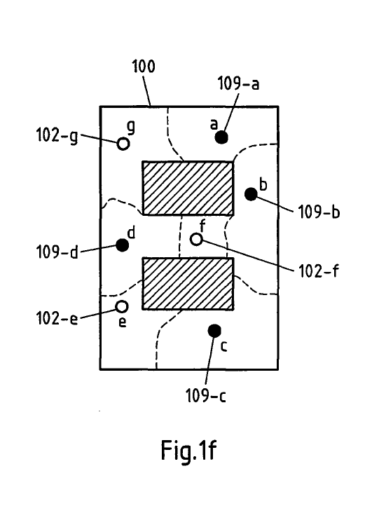

The location detection problem sets out from a target area 100 as depicted in FIG. 1a. This target area may for instance be an indoor target area with Radio Frequency (RF) obstructions (e.g. walls) 101-1 and 101-2.

As depicted in FIG. 1b, this target area 100 is then divided into a finite set of sub-regions, so-called location areas 103-a . . . 103-g, and each location area 103-a . . . 103-g is represented as a single point 102-a . . . 102-g, which indicates a respective potential beacon position.

The location areas 103-a . . . 103-g may for instance be defined in said target area so that a target, when residing in one of said location areas 103-a . . . 103-g, would be able to establish an RF link with a beacon positioned at the potential beacon position of said location area 103-a . . . 103-g, and furthermore with zero, one or more beacons positioned at further potential beacon positions in said target area. For instance, if a target resides somewhere in location area 103-a, it would be able to communicate with a beacon at point 102-a, and for instance, furthermore with beacons positioned at points 102-b and 102-g. Location areas 103-a . . . 103-g thus are formed based on the coverage areas (RF range) of beacons when positioned at potential beacon positions 102-a . . . 102-g in said target area 100. It is readily seen that the division of the target area 100 into location areas 103-a . . . 103-g may require measurements to be taken in the target area 100 in order to determine the actual radio coverage of the beacons when being positioned to the potential beacon positions 102-a . . . 102-g.

FIG. 1c illustrates the connectivity between the location areas 103-a . . . 103-g of FIG. 1b. Therein, reliable connectivity between a first and a second location area is understood as a situation where a target in a first location area can establish, with a high probability, a reliable connection with a beacon positioned at the potential beacon position of said second location area. For instance, according to FIG. 1c, reliable connectivity between location areas is illustrated by arrows between the potential beacon positions of those location areas.

As an example, location area 103-a has reliable connection with location area 103-b and 103-g. Thus a target located anywhere in location area 103-a is able to communicate with beacons positioned at points 102-a, 102-b and 102-g.

As shown in FIG. 1d, the points 102-a . . . 102-9 can be respectively mapped to the vertices 106-a . . . 106-g of a graph 105, and different vertices 106-a . . . 106-g are connected by edges if connectivity of their associated location areas 103-a . . . 103-g exists. Hence, the edges on the graph 105 represent (the high probability of being able to establish) RF links between targets and beacons of different location areas. It is noted that the robust design of the location detection system according to the present invention will take into account the fluctuation of RF links, which may either result in the temporary loss of a desired RF link or the temporary addition of an undesired RF link into the measurement set.

A solution is then sought for the following problem:

On which points 102-a . . . 102-g in the target area 100 (corresponding to the vertices 106-a . . . 106-g of the graph 105) should beacons be actually placed such that (1) each point 102-a . . . 102-g is covered by a unique subset of beacons (2) the solution is robust to missed detections and false detections and, for a given level of robustness, (3) we minimize the total required number of beacons?

The following definitions and notations apply in the understanding of this invention: G=(V,E) denotes a graph with vertices, V, and edges, E (cf. FIG. 1d). ρ(u,v) is defined as the number of edges along the shortest path from vertex u to vertex v. We define the ball of the vertex v, B(v), as

B(v)={w∈V:ρ(w,v)≦1}. (1)

A non-empty set, C⊂V, is called a code for a graph G and its elements are called codewords. Given a code for the graph, C, the corresponding code for a vertex v∈V of the graph G is defined to be

I_{c}(v)=B(v)∩C. (2)

A code is identifying if, for all u, v∈V:

I_{c}(u)≠I_{c}(v). (3)

The symmetric difference between the sets A and B is defined as

A⊕B=(A\B)∪(B\A). (4)

A code C⊂V for a graph is a “t-edge-robust” identifying code if the following three conditions hold:

i) |I_{c}(u)⊕I_{c}(v)≧t+1| (5-1)

for every two different vertices u, v∈V;

ii) |I_{c}(u)⊕I_{c}(v)|≧t+2 (5-2)

for every two different codewords u, v∈C which are not adjacent in G; and

iii) |I_{c}(u)|≧t+1 (5-3)

for every u∉C.
A code for a graph is a “t-vertex-robust” identifying code if the following two conditions hold:

i) |I_{c}(v)|≧t+1 (6-1)

for all v∈V; and

ii) |I_{c}(u)⊕I_{c}(v)|≧2t+1 (6-2)

for all u, v∈V, u≠v.

Applying this terminology to the graph G=(V,E) 105 of FIG. 1d, the vertices 106-a . . . 106-9 form the set V, the plurality of edges connecting the vertices 106-a . . . 106-g form the set E, and, for example, the ball of vertex 106-a can be identified as the set B(a)={a,b,g}.

FIG. 1e depicts an exemplary O-vertex-robust 1-identifying code (i.e. a t-vertex-robust 1-identifying code with t=0) C={a,b,c,d} for the graph 105 of FIG. 1d (vertices {a}, {b}, {c} and {d} of graph 105 are then considered as codewords). The codes (or identifying sets) for each vertex 106-a . . . 106-g of FIG. 1e is then easily derived by applying equation (2) (see Table 1 below):

TABLE 1
Vertices v of the graph of FIG. 1e with corresponding identifying sets.

| Vertex | a | b | c | d | e | f | g |
|---|---|---|---|---|---|---|---|
| Identi- | {a, b} | {a, b, | {b, c} | {d} | {c, d} | {b, d} | {a, d} |
| fying | | c} | | | | | |
| Set | | | | | | | |

As can be easily seen from the above Tab. 1, the identifying sets of all vertices 106-a . . . 106-g of the graph 105 of FIG. 1e are mutually different, so that the code C={a,b,c,d} is an identifying code.

Vertices 108-a, 108-b, 108-c and 108-d of the graph 105 of FIG. 1e represent points 102-a, 102-b, 102-c and 102-d in the target area 100 of FIG. 1b that are assigned beacons. This is depicted in FIG. 1f, wherein the points 102-a, 102-b, 102-c and 102-d that are assigned beacons are denoted as 109-a, 109-b, 109-c and 109-d, respectively. These beacons are considered to be sufficient to perform location detections of targets in the entire location area 100. However, since the robustness parameter t was chosen equal to 0, there is no robustness of the location detection system against missed detections and false alarms.

### FIRST ASPECT OF THE INVENTION

In the example of FIGS. 1a-1f, a 0-vertex-robust 1-identifying code was used to assign beacons to location areas in a target area in a location detection system. An identifying code depends on the topology of the graph it is applied in. To this end, the construction of identifying codes usually requires an algorithm that checks, for a given graph, which vertices of the graph do not have to be included into the code while still maintaining its robustness and identification characteristics (see for instance equations (5-1) . . . (5-3) and (6-1) . . . (6-2) above). This is generally accomplished by search algorithms. However, apart from the fact that determination of a suited identifying code may grow quite computationally complex, in particular for large graphs, it is generally hard to decide if an identifying code obtained from such a search is efficient or not, with efficiency being related to the number of required beacons. Thus even when a large number of different identifying codes has been determined for a given graph, and if the identifying code with the smallest cardinality is selected, there is no standard of comparison for the minimum required number of beacons.

To overcome this problem, according to the first aspect of the present invention, location detection is constrained to graphs with regular topologies. Given such a regular graph topology, closed form solutions can be applied to explicitly define the points in the target area at which one should place the beacons in order to create a robust and unique identifying set for each location area. Due to the assumption of a regular grid topology, the first aspect of the present invention may be most applicable when there are not any restrictions in the target area on where the beacons can be placed. The closed form solutions generally fall into two categories: (1) t-edge-robust 1-identifying codes and (2) t-vertex-robust 1-identifying codes.

A t-edge-robust 1-identifying code as defined by equations (5-1) . . . (5-3) above can uniquely determine every location area when the total number of false detections and missed detections does not exceed t. This solution addresses the problem that occurs when a beacon loses a radio link to one of its designated coverage areas (missed detection) and/or a beacon establishes a radio link to an area that is not in its coverage set (false detection). This solution is appropriate as long as the target is not located in the same location area as the beacon that fails.

A t-vertex-robust 1-identifying code as defined by equations (6-1) . . . (6-2) above is also a t-edge-robust 1-identifying code. The difference is that a t-vertex-robust 1-identifying code is robust to the loss of a beacon from its own identifying set, whereas the t-edge-robust 1-identifying code is constrained to link failures. This implies that targets that are located in the same location area as the failed beacon can still be unambiguously located and provides a more robust solution than a t-edge-robust 1-identifying code.

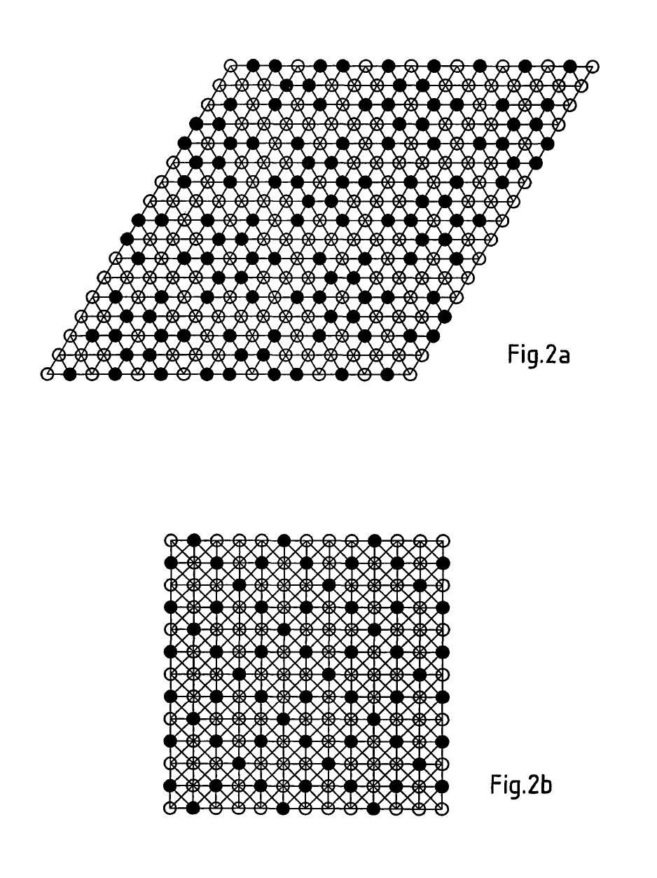

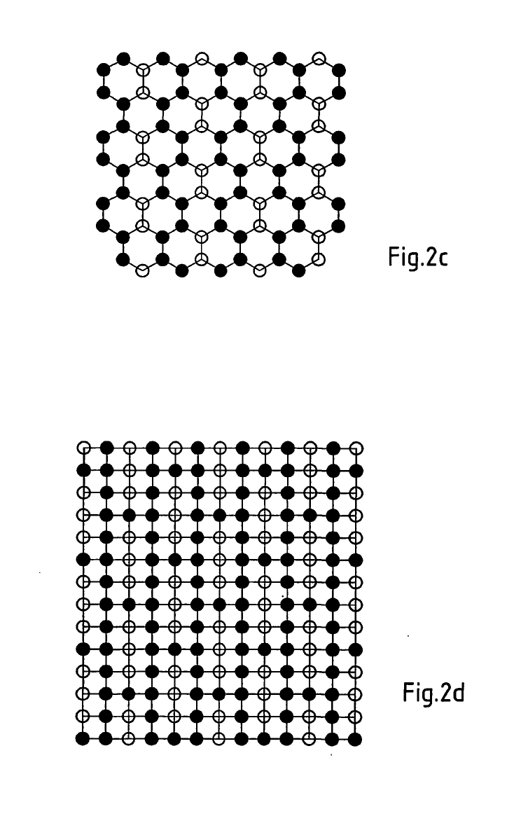

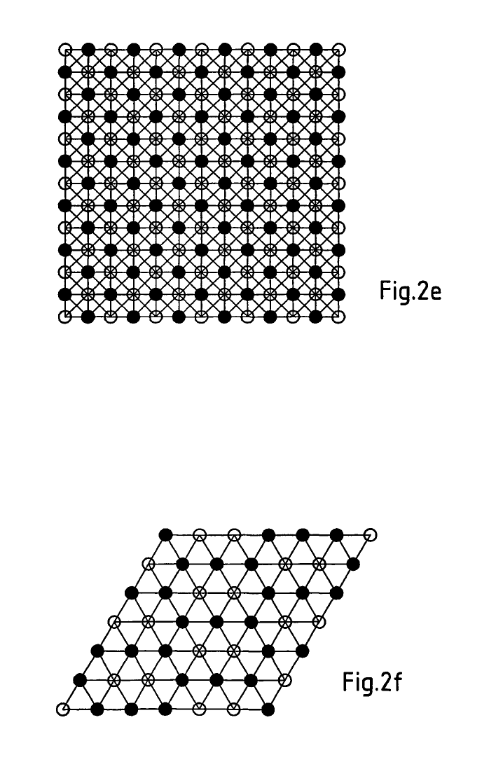

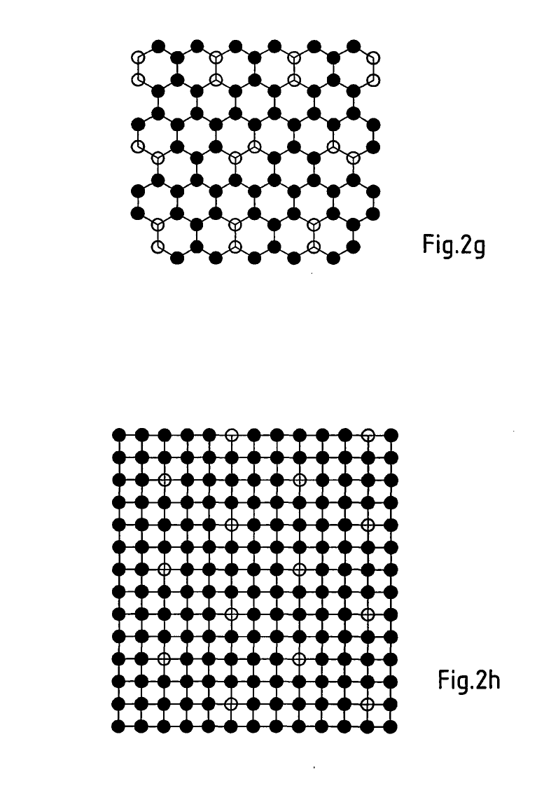

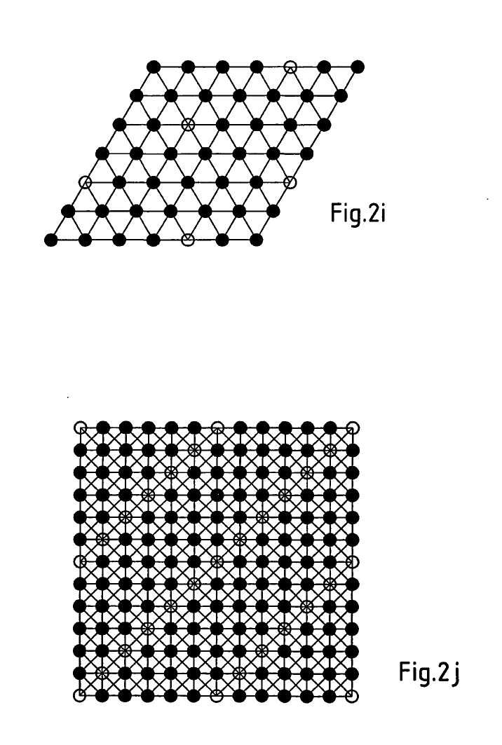

Based on the theoretical work in Honkala et al., there are certain regular graph topologies for which robust 1-identifying codes have been found. These robust 1-identifying codes are either optimal robust 1-identifying codes, i.e. codes with a density (ratio of codewords to total vertices of a graph) that equals the minimum density that can theoretically be achieved, or close-to-optimum codes which come close to this minimum density but do not actually achieve it. The solution sets (i.e. combinations of optimal or close-to-optimal t-edge-robust or t-vertex-robust 1-identifying codes and their corresponding regular graph topologies) that may be applied according to the first aspect of the present invention are enumerated below and depicted in FIGS. 2a-2j, accordingly (therein, a filled circle denotes a vertex that is included in the code, wherein a non-filled circle denotes a vertex that is not included in the code):
1. An optimal 1-edge-robust 1-identifying code with density 3/7 for the triangular topology (see FIG. 2a),
2. A 1-edge robust 1-identifying code with density 3/8 for the King's Lattice topology (see FIG. 2b),
3. An optimal 1-edge-robust 1-identifying code with density 2/3 in the hexagonal topology (see FIG. 2c),
4. An optimal 1-vertex-robust 1-identifying code with density 5/8 in the square topology (see FIG. 2d),
5. An optimal 1-vertex-robust 1-identifying code with density 1/2 in the King's Lattice topology (see FIG. 2e),
6. A 1-vertex-robust 1-identifying code with density 3/5 in the triangular topology (see FIG. 2f),
7. A 1-vertex-robust 1-identifying code with density 41/50 in the hexagonal topology (see FIG. 2g),
8. An optimal 2-vertex-robust 1-identifying code with density 11/12 in the square topology (see FIG. 2h),
9. An optimal 2-vertex-robust 1-identifying code with density 11/12 in the triangular topology (see FIG. 2i), and
10. An optimal 2-vertex-robust 1-identifying code with density 5/6 in the King's lattice topology (see FIG. 2j).

All of these combinations of codes and associated topologies are useful for 2D location area detection. However, one can also resolve location in a 3D area (for example an indoor building) by using a simple extension of these ideas. If the target's effective range of communication is limited to one floor, then one can easily resolve the floor on which it is located since only the beacons that are on the same floor will detect it. By using an orthogonal system in which one set of beacons are optimally deployed in the horizontal plane and a second set of beacons are optimally deployed in the vertical plane (independently of one another), one can unambiguously determine the 3D location solution.

The above-listed identifying codes (see also FIGS. 2a-2j) provide unambiguous location area detection for infinite regular topologies. However, since the deployment area is finite, it may be necessary to additionally deploy further beacons around the perimeter of the target area in order to avoid edge effects.

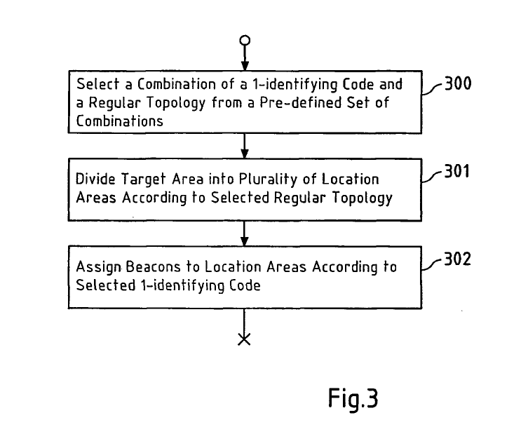

FIG. 3 depicts a flowchart of an exemplary embodiment of a method for positioning beacons in a target area of a location detection system according to the first aspect of the present invention.

In a first step 300, a combination of a 1-identifying code and a regular topology is selected from a pre-defined set of combinations. This set may for instance comprise the 10 combinations listed above, or sub-groups thereof, for instance only combinations for one specific topology, or only combinations with optimal codes, or similar. Therein, selection of one particular topology may for instance be based on the layout of the target area, the ease of installation, the number of required beacons or other influential factors. Selection of one particular 1-identifying code may for instance be based on the desired robustness of the location detection system in terms of the robustness parameter t and/or the decision whether a t-edge-robust or a t-vertex-robust code is required.

In a second step 301, the target area of the location detection system is then divided into a plurality of location areas according to the selected regular topology. Therein, it is noted that steps 300 and steps 301 may equally well be combined into a joint process, since it may be required to adapt the lay-out of the location areas to the regular topologies or to choose topologies according to possible location area lay-outs.

Finally, in a step 302, beacons are assigned to location areas according to the selected 1-identifying code, so that each location area has a unique identifying set.

### SECOND ASPECT OF THE INVENTION

The second aspect of the present invention is directed to the positioning of beacons in a target area of a location detection system without requiring any restriction of the topology of the graph that represents the location areas and their connectivity, and to a location detection system itself. The principles of the second aspect of the present invention are thus applicable to determine robust 1-identifying codes for irregular graphs, as for instance the graph 105 in FIG. 1d.

As already described with reference to FIGS. 1a-1d above, beacon positioning according to the second aspect of the present invention comprises dividing the target area into a plurality of location areas that are respectively associated with potential beacon positions and characterized by their mutual connectivity, and representing the location areas and their connectivity by vertices and edges of a graph.

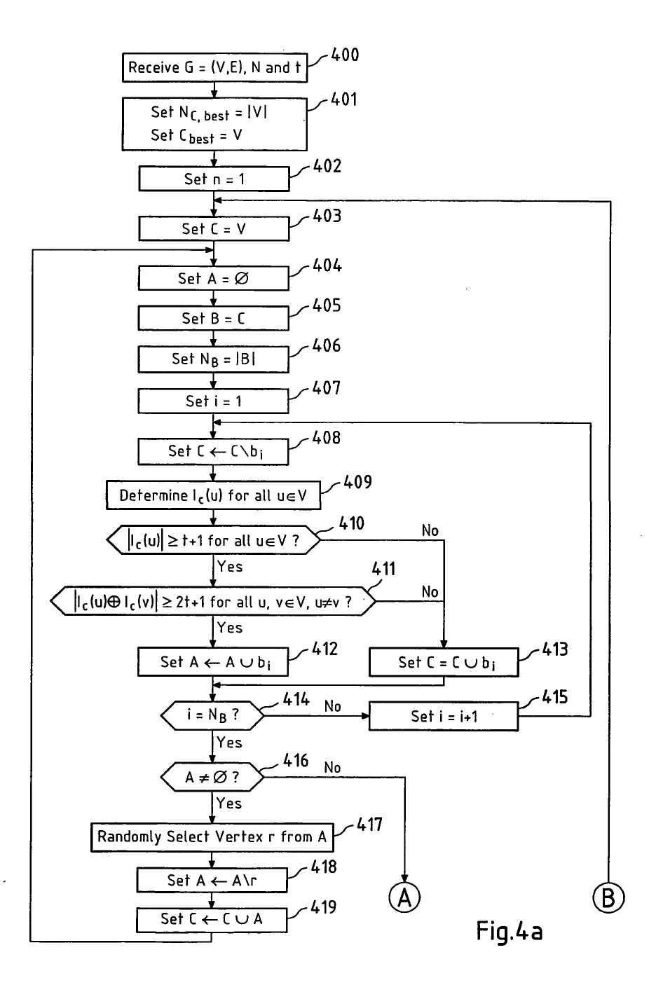

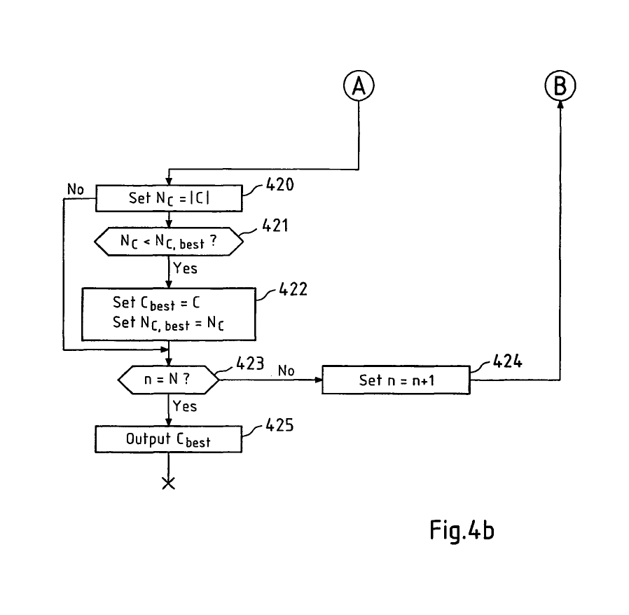

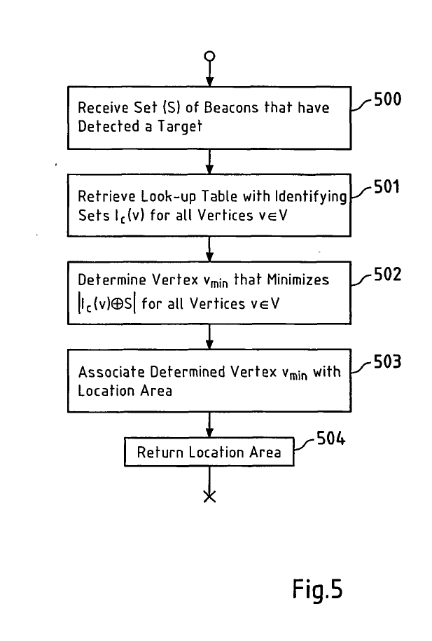

According to the second aspect of the present invention, then a locally optimal solution of a t-vertex-robust 1-identifying code for said graph (with arbitrary topology) is determined by using a randomised greedy search algorithm that attempts, at every iteration, to reduce the number of beacons that are a part of the solution set. The algorithm is independently repeated a number of times (N) to find the solution that uses the smallest number of beacons and thus achieves the highest efficiency, as will be explained in more detail with reference to FIG. 4 below.

After said locally optimum t-vertex-robust 1-identifying code has been determined, beacons are assigned to potential beacon positions of location areas of the target area as prescribed by the code.

FIGS. 4a and 4b jointly depict a flowchart of an exemplary embodiment of a search algorithm for determining a t-vertex-robust 1-identifying code for an arbitrary graph according to the second aspect of the present invention.

In a first step 400, a graph G defined by a set of vertices V and a set of edges E is received by the algorithm, as well a choice for the robustness parameter t and a selection for the number of runs N of the algorithm. In a step 401, then a variable N_{C,best} is set equal to the cardinality of the set V, and a set C_{best} is set equal to V. In the course of the algorithm, C_{best} will always contain the code with the smallest cardinality yet determined, and N_{C,best} will contain the corresponding cardinality. In step 402, a loop counter n is initialized to 1. Loop counter n counts the number of runs of the algorithm, wherein in each run, a different t-vertex-robust 1-identifying code for graph G is determined.

In a step 403, then a code C is initialized by setting it equal to the set of vertices V. Furthermore, in a step 404, a set A is initialized. This set A will contain all vertices that, if removed from said set C, would still cause the remaining vertices in said set C to represent a t-vertex-robust 1-identifying code for said graph. In a step 405, furthermore a set B is set equal to the set C. The set B remembers all vertices originally contained in C, since C will be reduced during the subsequent steps of the algorithm. In step 406, also the cardinality of the set B is remembered by means of a variable NB.

In the next steps 407 to 415, said set A is determined for a given set C. To this end, first a loop counter i is initialized to 1 in a step 407. Then, in a step 408, the i-th vertex bᵢ from set B (which remembers set C in its original form) is removed from set C, and the remaining set is stored as set C. In a step 409, then the identifying sets (see equation (2)) I_{c}(v) for all vertices of the graph G are determined. In steps 410 and 411, it is then checked if the set C, after removal of the vertex bᵢ, still is a t-vertex-robust 1-identifying code (see the conditions in equations (6-1) and (6-2) above). If this is the case, the vertex bᵢ is copied into the set A in a step 412. Otherwise, the vertex bᵢ is copied back into the set C in a step 413. In a step 414, it is checked if all vertices of the set B of cardinality NB have already been tested. If this is not the case, the loop counter i is incremented by one in a step 415, and the algorithm jumps back to step 408 for removal of the next vertex bᵢ. Otherwise, all vertices of the set B (i.e. the original set C) have been tested. Vertices that can be removed from the set C without affecting its property to be a t-vertex-robust 1-identifying code are then contained in the set A.

In step 416, it is determined if the set A is not empty. If this is the case, steps 417-419 are performed in order to randomly select one vertex r from set A (step 417), to remove this vertex r from A (step 418) and to put all remaining vertices of set A back into the set C (step 419). The algorithm then jumps back to step 404. Steps 404 to 419 are then repeated, but now for a set C that, in comparison to the first run of steps 404 to 419, comprises one vertex less, wherein this vertex was randomly selected from the set A of “dispensable” vertices of the set C. Steps 404 to 419 are repeated (and the set C accordingly reduced by one vertex in each repetition) until it is determined in step 416 that the set A is empty (the set C then is irreducible, i.e. further removal of vertices would cause the set C to no longer represent a t-vertex-robust 1-identifying code).

If it is decided in a step 416 that the set A is empty, the cardinality N_{C} of the obtained (irreducible) set C is determined in a step 420. If this cardinality N_{C} is smaller than the (so far) smallest cardinality N_{C,best}, which is checked in a step 421, the set C is stored as set C_{best}, and N_{C,best} is set equal to N_{C} as “new” smallest cardinality. In a step 423, the loop counter n is checked against the number N of desired runs of the algorithm. If the desired number of runs has already been reached, the algorithm proceeds to step 425 and outputs the stored set C_{best}. Otherwise, the loop counter n is incremented by one in a step 424, and the method jumps back to step 403 to determine a new (irreducible) set C. The random removal of vertices according to step 417 ensures that there is a high probability that the (irreducible) sets C determined in each run n=1 . . . N are mutually different and thus may have different cardinalities.

FIG. 5 depicts a flowchart of an exemplary embodiment of a method for detecting a location of a target in a location detection system according to the first and second aspect of the present invention. This method may for instance be performed by a target location detection unit that is connected to the beacons of a location detection system. In a first step 500, a set of beacons S containing all beacons that have detected a specific target (which may for instance be identified by an ID) is received. In a step 501, then a look-up table containing the identifying sets I_{c}(v) (in the absence of errors) for all vertices v∈V of the graph G=(V,E) that represents the location areas (V) of the target area and their connectivity (E) is retrieved, for instance from a memory of said target location detection unit. Said look-up table may for instance resemble Tab. 1 as defined in the context of the description of FIGS. 1a-1f above. In a step 502, then the vertex vₘᵢₙ∈V is determined that minimizes the cardinality of the symmetric difference between the identifying set I_{c}(v) and the set of beacons S. For instance, with respect to Tab. 1, if the set S={b,c} is received, vₘᵢₙ will be detected as vₘᵢₙ={c}. In a step 503, then the determined vertex vₘᵢₙ is associated with a location area in the target area, and this location area is returned in step 504.

The location detection systems according to the first and second aspect of the present invention can be applied in the context of 2D and 3D indoor and outdoor location detection and for different physical media for the signal exchange between targets and beacons. Apart form radio links, equally well optical links may be used. Furthermore, the signal exchange does not necessarily have to be wireless, it may equally well be wire-bound. In a wireless system based on radio links, for instance wireless protocols such as Bluetooth, RFID, WLAN, Ultra-wideband or similar wireless protocols may be used. Furthermore, said location detection system may at least partially be implemented by a wireless communication system or may be an add-on of such a wireless communication system.

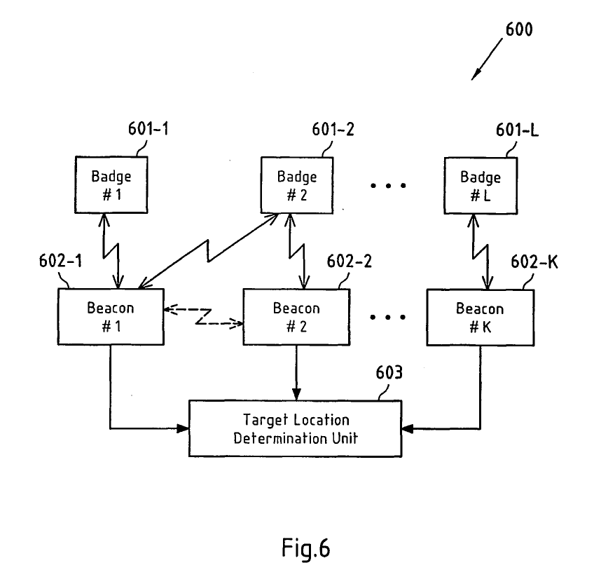

As an example for an actual implementation of location detection systems according to the first and second aspect of the present invention, a Bluetooth-based system 600 will now be considered with reference to FIG. 6. This invention may be particularly well suited for use with the Bluetooth protocol since it is a short-range (˜10 m) cost-effective technology. The Bluetooth location detection network is comprised of L mobile “badges” 601-1 . . . 601-L (i.e. devices that are equipped with Bluetooth and which can acquire their location) as targets and K static Bluetooth devices 602-1 . . . 602-K that operate as beacons. Some of the beacons 602-1 . . . 602-K may be designated to be Bluetooth masters while others are designated to be slaves. The beacons 602-1 . . . 602-K can be positioned in the location areas of the target area according to the methods for positioning beacons of the first or second aspect of the present invention. Since a Bluetooth master can communicate with no more than seven active slaves, beacons may for instance be arranged so that any beacon has, at most, seven closest neighbours within its communication range. With respect to the first aspect of the present invention, where only regular topologies are considered, it is seen that, apart from the King's lattice topology of FIG. 2e (which would require the master to communicate with eight active slaves), all of the regular topologies mentioned in the context of the first aspect of the present invention could very easily be interpreted in terms of master-slave arrangements.

The beacons 602-1 . . . 602-K periodically scan their local areas by means of Bluetooth inquiry calls, and the Bluetooth badges 601-1 . . . 601-L respond by means of FHS (Frequency Hopping Synchronization) packets. This signalling is illustrated in FIG. 6 by means of arrows between the badges 601-1 . . . 601-L and the beacons 602-1 . . . 602-K. A beacon that detects an FHS extracts the Bluetooth device address (BD_ADDR) and compares it to the existing badge addresses in its cache. If it is a new badge, then the beacon creates a location packet and sends it to the beacon that is at the top of its routing table (Therein, routing ensures that in situations where the beacon that creates the location packet is not within range of the target location determination unit 603, location packets are routed via one or more beacons to the target location detection unit 603.). If, however, the badge address has already been stored in the cache, the beacon does not create a new location packet. If, during the present inquiry cycle, the beacon fails to discover a badge that was previously detected, it creates a new location packet to indicate the deletion of that badge from its location area, and it also deletes that badge address from its cache. The target location determination unit 603, which is connected to the beacons 602-1 . . . 602-K by means of wire-bound or wireless links, is responsible for filtering the location packets in order to determine the location area of each Bluetooth badge 601-1 . . . 601-L.

The location detection system according to the first and second aspect of the present invention also address beacon fault detection since the Bluetooth beacons 602-1 . . . 602-K can also answer the Bluetooth inquiries, as exemplarily indicated by the dashed arrow between beacon 601-1 and 602-2 in FIG. 6. Each beacon 602-1 . . . 602-K maintains a cache that stores the badge addresses of the other beacons. When a beacon (e.g. beacon 602-1) fails to receive an FHS packet from any member of its identifying set (e.g. beacon 602-2) within a certain period of time, it forwards a location packet through the network to warn of a possible beacon failure. The location detection system 600 then checks to see if any other beacons have reported the same failure and takes appropriate action based on the outcome of its investigation.

The location detection systems according to the first and second aspect of the present invention do not rely on the use of GPS or on the cellular infrastructure in order to locate the terminal and are particularly well suited, but not limited, to work indoors, where other location detection technologies tend to perform poorly. For both regular and irregular graph topologies, the present invention allows for robust and efficient location detection. When the location detection systems according to present invention are integrated into a wireless communication system, only software modifications to the terminals of the wireless communication system may be required so that the terminals are capable of performing location-related processes (in terminal-assisted mode, i.e. a mode where location detection is performed by the terminals), such as for instance determining from which access units of the wireless communication system that serve as beacons signals can be received, and/or sending location-related information to a network entity (in network-assisted mode, i.e. a mode where location detection is performed by an entity of the wireless communication system).

The location detection system according to the present invention may particularly not require the target (or terminal) to measure time of arrival, angle of arrival or strength of arrival, which means that it does not have to address many of the fundamental issues (e.g. non-line-of-sight error, multi-path) that conventionally affect location detection precision. Furthermore, the systems are designed to be robust so that they can accommodate missed detections and false detections.

As already stated, the location detection systems according to the present invention may be completely or partially incorporated into a wireless communication system. In case of only partial incorporation or co-existence with a wireless communication system, it may be required to configure the location detection systems so that they do not harmfully interfere with the wireless communication system. For example, in a WLAN implementation, a WLAN location determination system should then not harmfully interfere with an existing WLAN communication system deployment.

The invention has been described above by means of exemplary embodiments. It should be noted that there are alternative ways and variations which are obvious to a skilled person in the art and can be implemented without deviating from the scope and spirit of the appended claims.

1. A method for positioning beacons in a target area of a location detection system, said method comprising:
dividing said target area into a plurality of location areas associated with potential beacon positions, wherein said location areas are represented by vertices of a graph, wherein reliable connectivity between location areas is represented by edges between vertices that represent said location areas, and wherein said graph has a regular topology; and
assigning said beacons to location areas that are represented by a sub-set of vertices of said graph, wherein said sub-set of vertices represents a t-edge-robust or a t-vertex-robust 1-identifying code, and wherein t is a pre-defined integer number.

2. The method according to claim 1, wherein a pre-defined set of possible combinations of t-edge-robust or t-vertex-robust 1-identifying codes and regular topologies exists, said method further comprising:
selecting one of said possible combinations of 1-identifying codes and regular topologies of said pre-defined set, wherein said dividing of said target area into a plurality of location areas is performed based on said topology of said selected combination of 1-identifying codes and regular topologies, and wherein said assigning of said beacons to said location areas is performed based on said 1-identifying code of said selected combination of 1-identifying codes and regular topologies.

3. The method according to claim 2, wherein said selecting is performed under consideration of characteristics of said target area or said location detection system or both.

4. The method according to claim 1, wherein said regular topology is a triangular topology, and wherein said 1-identifying code is an optimal 1-edge-robust 1-identifying code with density 3/7, a 1-vertex-robust 1-identifying code with density 3/5 or an optimal 2-vertex-robust 1-identifying code with density 11/12.

5. The method according to claim 1, wherein said regular topology is a King's lattice topology, and wherein said 1-identifying code is a 1-edge-robust 1-identifying code with density 3/8, an optimal 1-vertex-robust 1-identifying code with density 1/2 or an optimal 2-vertex-robust 1-identifying code with density 5/6.

6. The method according to claim 1, wherein said regular topology is a hexagonal topology, and wherein said 1-identifying code is an optimal 1-edge-robust 1-identifying code with density 2/3, or a 1-vertex-robust 1-identifying code with density 41/50.

7. The method according to claim 1, wherein said regular topology is a square topology, and wherein said 1-identifying code is an optimal 1-vertex-robust 1-identifying code with density 5/8 or an optimal 2-vertex-robust 1-identifying code with density 11/12.

8. The method according to claim 1, wherein said target area of said location detection system at least partially overlaps with a coverage area of a wireless communication system, and wherein at least some of said beacons serve as access units of said wireless communication system.

9. The method according to claim 8, wherein said positioning of said beacons of said location detection system serving as access units of said wireless communication system is performed under consideration of said assignment of said beacons to said location areas and under additional consideration of characteristics of said wireless communication system.

10. A location detection system, comprising a plurality of beacons positioned in a target area, wherein said target area is divided into a plurality of location areas associated with potential beacon positions, wherein said location areas are represented by vertices of a graph, wherein reliable connectivity between location areas is represented by edges between vertices that represent said location areas, wherein said graph has a regular topology, wherein said beacons are positioned in location areas that are represented by a sub-set of vertices of said graph, wherein said sub-set of vertices represents a t-edge-robust 1-identifying code or a t-vertex-robust 1-identifying code, and wherein t is a pre-defined integer number.

11. The location detection system according to claim 10, wherein said regular topology is a triangular topology, and wherein said 1-identifying code is an optimal 1-edge-robust 1-identifying code with density 3/7, a 1-vertex-robust 1-identifying code with density 3/5 or an optimal 2-vertex-robust 1-identifying code with density 11/12.

12. The location detection system according to claim 10, wherein said regular topology is a King's lattice topology, and wherein said 1-identifying code is a 1-edge-robust 1-identifying code with density 3/8, an optimal 1-vertex-robust 1-identifying code with density 1/2 or an optimal 2-vertex-robust 1-identifying code with density 5/6.

13. The location detection system according claim 10, wherein said regular topology is a hexagonal topology, and wherein said 1-identifying code is an optimal 1-edge-robust 1-identifying code with density 2/3, or a 1-vertex-robust 1-identifying code with density 41/50.

14. The location detection system according to claim 10, wherein said regular topology is a square topology, and wherein said 1-identifying code is an optimal 1-vertex-robust 1-identifying code with density 5/8 or an optimal 2-vertex-robust 1-identifying code with density 11/12.

15. The location detection system according to claim 10, further comprising:
a plurality of targets; and
a target location determination unit;
wherein targets are at least temporarily associated with beacons, wherein beacons forward identifiers of their associated targets to said target location determination unit, and wherein said target location determination unit is capable of determining a location area of a target based on an evaluation of those beacons that are known to be associated with said target.

16. The location detection system according to claim 10, wherein at least one beacon of said location detection system at least occasionally checks operability of at least one other beacon of said location detection system.

17. The location detection system according to claim 10, wherein said target area of said location detection system at least partially overlaps with a coverage area of a wireless communication system, and wherein at least some of said beacons serve as access units of said wireless communication system.

18. The location detection system according to claim 17, wherein said positioning of said beacons of said location detection system serving as access units of said wireless communication system is at least partially performed under additional consideration of characteristics of said wireless communication system.

19. A software application for positioning beacons in a target area of a location detection system, said software application comprising:
program code for dividing said target area into a plurality of location areas associated with potential beacon positions, wherein said location areas are represented by vertices of a graph, wherein reliable connectivity between location areas is represented by edges between vertices that represent said location areas, and wherein said graph has a regular topology; and
program code for assigning said beacons to location areas that are represented by a sub-set of vertices of said graph, wherein said sub-set of vertices represents a t-edge-robust or a t-vertex-robust 1-identifying code, and wherein t is a pre-defined integer number.

20. A software application product, comprising a storage medium having a software application according to claim 19 embodied therein.

21. A method for positioning beacons in a target area of a location detection system, wherein location areas are associated with potential beacon positions in said target area and are represented by vertices of a graph, wherein reliable connectivity between location areas is represented by edges between vertices that represent said location areas, and wherein all vertices of said graph form a set V; said method comprising:
determining a plurality of sets C, each of said sets C being determined by repeating, until a set A is determined to be empty, the following steps:
determining said set A as a set of all vertices that, if removed from said set C, would still cause the remaining vertices in said set C to represent a t-vertex-robust 1-identifying code for said graph, wherein t is a pre-defined integer number, and wherein for the determining of each of said plurality of sets C, said set V is used as an initialization for said set C;
removing, if said set A is non-empty, one randomly selected vertex of said set A from said set C to obtain said set C for said next determining of said set A; and
returning, if said set A is empty, said set C as the result of said determining of said set C; and
assigning said beacons to those location areas that are represented by vertices of that set C of said plurality of determined sets C that has the smallest cardinality.

22. The method according to claim 21, wherein said target area of said location detection system at least partially overlaps with a coverage area of a wireless communication system, and wherein at least some of said beacons serve as access units of said wireless communication system.

23. The method according to claim 22, wherein said positioning of said beacons of said location detection system serving as access units of said wireless communication system is performed under consideration of said assignment of said beacons to said location areas and under additional consideration of characteristics of said wireless communication system.

24. A location detection system, comprising a plurality of beacons positioned in a target area, wherein said beacons are positioned in said target area according to an assignment of beacons to location areas of said target area, wherein said location areas are associated with potential beacon positions in said target area and are represented by vertices of a graph, wherein reliable connectivity between location areas is represented by edges between vertices that represent said location areas, wherein all vertices of said graph form a set V, and wherein a determination of said assignment of said beacons to said location areas comprises:
determining a plurality of sets C, each of said sets C being determined by repeating, until a set A is determined to be empty, the following steps:
determining said set A as a set of all vertices that, if removed from said set C, would still cause the remaining vertices in said set C to represent a t-vertex-robust 1-identifying code for said graph, wherein t is a pre-defined integer number, and wherein for the determining of each of said plurality of sets C, said set V is used as an initialization for said set C;
removing, if said set A is non-empty, one randomly selected vertex of said set A from said set C to obtain said set C for said next determining of said set A; and
returning, if said set A is empty, said set C as the result of said determining of said set C; and
assigning said beacons to those location areas that are represented by vertices of that set C of said plurality of determined sets C that has the smallest cardinality.

25. The location detection system according to claim 24, further comprising:
a plurality of targets; and
a target location determination unit;
wherein targets are at least temporarily associated with beacons, wherein beacons forward identifiers of their associated targets to said target location determination unit, and wherein said target location determination unit is capable of determining a location area of a target based on an evaluation of those beacons that are known to be associated with said target.

26. The location detection system according to claim 24, wherein at least one beacon of said location detection system at least occasionally checks operability of at least one other beacon of said location detection system.

27. The location detection system according to claim 24, wherein said target area of said location detection system at least partially overlaps with a coverage area of a wireless communication system, and wherein at least some of said beacons serve as access units of said wireless communication system.

28. The location detection system according to claim 27, wherein said positioning of said beacons of said location detection system serving as access units of said wireless communication system is at least partially performed under additional consideration of characteristics of said wireless communication system.

29. A software application for positioning beacons in a target area of a location detection system, wherein location areas are associated with potential beacon positions in said target area and are represented by vertices of a graph, wherein reliable connectivity between location areas is represented by edges between vertices that represent said location areas, and wherein all vertices of said graph form a set V; said software application comprising:
program code for determining a plurality of sets C, each of said sets C being determined by repeating, until a set A is determined to be empty, the following steps:
determining said set A as a set of all vertices that, if removed from said set C, would still cause the remaining vertices in said set C to represent a t-vertex-robust 1-identifying code for said graph, wherein t is a pre-defined integer number, and wherein for the determining of each of said plurality of sets C, said set V is used as an initialization for said set C;
removing, if said set A is non-empty, one randomly selected vertex of said set A from said set C to obtain said set C for said next determining of said set A; and
returning, if said set A is empty, said set C as the result of said determining of said set C; and
program code for assigning said beacons to those location areas that are represented by vertices of that set C of said plurality of determined sets C that has the smallest cardinality.

30. A software application product, comprising a storage medium having a software application according to claim 29 embodied therein.
